(19) United States
(12) Patent Application Publication
(10) Pub. No.: US 2006/0173093 A1
(43) Pub. Date: Aug. 3, 2006

(54) Ink composition, ink jet printing apparatus, and printing process

(76) Inventors: Seung-min Ryu, Yongin-si (KR); Yeon-kyoung Jung, Suwon-si (KR); Su-aa Jung, Suwon-si (KR)

Correspondence Address: STANZIONE & KIM, LLP, 919 18TH STREET, N.W., SUITE 440, WASHINGTON, DC, 20006, US

(21) Appl. No.: 11/332,366

(22) Filed: Jan. 17, 2006

(30) Foreign Application Priority Data
Feb. 2, 2005 (KR) 2005-9730

(51) Int. Cl. C03C 17/00

(52) U.S. Cl. 523/160

(57) ABSTRACT

An ink composition comprising a coloring agent, a surfactant, a liquid vehicle, and a co-solvent comprising a hetero atom having at least one unshared electron pair; an ink jet printing apparatus containing the ink composition, and a printing process using the ink composition.

### CROSS-REFERENCE TO RELATED APPLICATIONS

This application claims priority from Korean Patent Application No. 10-2005-0009730, filed on Feb. 2, 2005, in the Korean Intellectual Property Office, which is incorporated herein in its entirety by reference.

### BACKGROUND

1. Technical Field

The present general inventive concept relates to an ink composition that can be stably stored for a long time without clogging a nozzle of an ink printing apparatus, and without foaming.

2. Description of the Related Art

In inkjet printing apparatuses, ink droplets are ejected through a fine nozzle to form an image on a medium. An ink composition must dry quickly on the medium; must not bleed; must be uniform on various media; must not mix a boundary between colors; and must have excellent durability, such as excellent water resistance, light resistance, and rub resistance.

In order to develop an ink composition having these properties, various types of ink compositions have been proposed. For example, by using fast-drying ink compositions, printing can be performed at a high speed and the mixing of different colors can be prevented. An ink composition can be dried through two mechanisms: evaporation and penetration. The evaporation is dependent on the vapor pressure of the ink composition, and the penetration is dependent on the difference in the surface energies of the ink composition and the medium.

Penetration of the medium by the ink composition can be facilitated by the use of various surfactants. When an ink composition quickly-penetrates a medium, the drying time of the ink composition can be decreased and the mixing of different colors can be prevented. However, the surfactant contributes to the formation of bubbles in the ink composition so that the volume of ink is increased by 400% to 500% of the initial volume of the ink composition when no surfactant is included, thus adversely affecting the discharge of the ink composition. In order to prevent this problem, an anti-forming agent can be included in the ink composition. The anti-forming agent may be a poly siloxane polymer compound or an F-containing carbon compound, such as Foamex 800, 805, 810, 815, 835, or 842 (obtained from TEGO Inc); BYK-019, 021, 022, 023, 024, 025, 028 (obtained from BYK Inc.); Surfynol DF-695 (obtained from Air Product Inc.); or the like.

When the anti-forming agent is added to the ink composition, foaming can be prevented; however, the viscosity of the ink composition is increased because the anti-forming agent has a large molecule weight. Because of the high viscosity, the ink composition is not easily discharged, and thus a nozzle in a cartridge can become clogged.

### SUMMARY

The present general inventive concept provides an ink composition which can be stably stored for a long time without clogging a nozzle of an ink printing apparatus, and without foaming.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an ink composition that includes a coloring agent, a surfactant, a liquid vehicle, and a co-solvent.

The surfactant may include an oligomer with a number average molecular weight (Mn) of about 8000 or less, for example about 3000 or less, or about 50 to about 2200. The amount of the surfactant may be in a range of about 0.01 to about 9 parts by weight based on 100 parts by weight of the ink composition, for example, about 0.07 to about 7 parts by weight based on 100 parts by weight of the ink composition.

The co-solvent may include at least one compound selected from a C1-C20 ether, a C1-C20 ester compound, a C1-C20 carbonate-based compound, and a C1-C20 sulfur containing compound, and the at least one compound may contain a hetero atom having at least one unshared electron pair.

### DETAILED DESCRIPTION

The foregoing and/or other aspects and utilities of the present general inventive concept are achieved by providing an ink composition that includes a coloring agent, a liquid vehicle, a surfactant, and a co-solvent.

In embodiments, the surfactant may be ionic, zwitterionic, or nonionic. An amount of the surfactant may be in a range of about 0.01 to about 9 parts by weight, such as about 0.07 to about 7 parts by weight, based on 100 parts by weight of the ink composition. When the amount of the surfactant is less than about 0.01 parts by weight, the desired wetting of the ink composition may not be obtained. When the amount of the surfactant is greater than about 9 parts by weight, it is difficult to obtain sufficient wetting and to maintain fluidity of the ink composition, and thus an excessive amount of the ink composition may be discharged from an ink head, and the ink composition may remain on a surface of a nozzle.

In embodiments, a volume of foam may be about 300% or less, such as about 250% or less, than an initial volume of the ink composition.

In embodiments, the co-solvent may include at least one compound selected from a C1-C20 ether, a C1-C20 ester compound, and a C1-C20 sulfur containing compound, and the at least one compound contains a hetero atom having at least one unshared electron pair.

In embodiments, the number average molecular weight (Mn) of the surfactant may be about 8000 or less, such as about 3000 or less or about 50 to about 2200. When the number average molecular weight (Mn) of the surfactant is greater than about 8000, the viscosity of the ink composition is increased substantially, even when the amount of the surfactant is very small. As a result, it is difficult for the ink composition to be discharged from a nozzle of an ink head. In addition, even when the sitting time of the ink composition is very short, the ink composition may harden on the surface of the nozzle of the head and thus becomes less useful or useless.

In embodiments, a weight ratio of the surfactant to the co-solvent may be in a range of about 1:4000 to about 9:1, such as about 1:570 to about 7:1 or about 1:200 to about 5:1. When the amount of the co-solvent with respect to the surfactant exceeds this range, the viscosity of the ink increases and proper surface tension cannot be obtained. On the other hand, when the amount of the co-solvent with respect to the surfactant is less then this range, bubbles formed due to the presence of the surfactant in the ink composition rarely burst.

Generally, an anti-foaming agent may be composed of a bubble-philic portion and a hydrophilic portion. The bubble-philic portion of the anti-foaming agent penetrates a bubble film formed in a solution and is radially dispersed, so that the bubble becomes thinner and finally bursts. In embodiments, the co-solvent includes a hetero atom containing an unshared electron pair as the bubble philic portion. The hetero atom containing an unshared electron pair destroys bubbles of the ink composition generated by the surfactant. In particular, the co-solvent has a low molecular weight and thus the increase in the viscosity of the ink composition may be very small, contrary to conventional anti-foaming agents composed of a siloxane copolymer. Therefore, foaming of the ink composition can be suppressed while stability of the ink composition for discharging is maintained and clogging of a nozzle is prevented.

In embodiments, the co-solvent may be one or more members selected from diethyleneglycol, triethyleneglycol, tetrahydrofuran, dioxane, ethyl acetate, ethyl lactate, ethylene carbonate, propylene carbonate, diethyleneglycol monobutyl ether, triethyleneglycol monobutyl ether, propylene glycol monobutyl ether, dipropylene glycol monobutylether dimethylsulfoxide, tetramethylenesulfone, butadienesulfone, thioglycol, 2-methylthioethanol, mixtures thereof, and the like. However, the co-solvent is not limited to these examples.

In embodiments, an amount of the co-solvent in the ink composition may be in a range of about 1 to about 40 parts by weight based on 100 parts by weight of the ink composition. When the amount of the co-solvent is less than about 1 part by weight, foaming is not sufficiently suppressed. When the amount of the co-solvent is greater than about 40 parts by weight, the viscosity of the ink composition is increased significantly.

The coloring agent according to the present general inventive concept is not limited. For example, the coloring agent may be a water-soluble or dispersible dye, a pigment that can be used with a dispersing agent to be stably dispersed in water, a self-dispersible pigment that can be stably dispersed in water without a dispersible agent, or mixtures thereof.

In embodiments, the dye may be a dye selected from Food Black Dyes, Food Red Dyes, Food Yellow Dyes, Food Blue Dyes, Acid Black Dyes, Acid Red Dyes, Acid Blue Dyes, Acid Yellow Dyes, Direct Black Dyes, Direct Blue Dyes, Direct Yellow Dyes, anthraquinone dyes, monoazo dyes, disazo dyes, phthalocyanine derivatives, and similar materials. The examples of the pigment include carbon black, graphite, vitreous carbon, activated charcoal, activated carbon, anthraquinone, pthalocyanine blue, pthalocyanine green, diazos, monoazos, pyranthrones, perylene, quinacridone, indigoid pigments, and similar materials. In embodiments, the self-dispersible pigment may be selected from cabojet-series, CW-series of orient chemical, and similar materials. However, the coloring agent is not limited to these compounds.

In embodiments, an amount of the coloring agent in the ink composition may be in a range of about 1 to about 15 parts by weight, such as about 1 to about 10 parts by weight, based on 100 parts by weight of the ink composition.

In embodiments, the surfactant may include a salt of C1-C1000 alkylcarboxylic acid (such as a salt of C10-C200 alkylcarboxylic acid), a salt of C1-C1000 alcohol sulfonic acid ester (such as a salt of C10-C200 alcohol sulfonic acid ester), a salt of C1-C1000 alkylsulfonic acid (such as C10-C200 alkylsulfonic acid), a salt of C1-C1000 alkylbenzenesulfonic acid (such as C10-C200 alkylbenzenesulfonic acid), and mixtures thereof; a fatty acid amine salt, a tertiary ammonium salt, a sulfonium salt, a phosphonium salt, a salt, and mixtures thereof; a polyoxyethylene alkyl ether containing a C1-C1000, (such as a C10-C200 alkyl group) a polyoxyethylene alkyl phenyl ether containing a C1-C1000, (such as a C10-C200 alkyl group) a polyoxyethylene secondary alcohol ether, polyoxyethylene-oxypropylene block copolymer, polyglycerine ester of fatty acids, sorbitane ester of fatty acids, and mixtures thereof; an acetylenic glycol compound, a secondary alcohol ethoxylate compound, and mixtures thereof; or similar materials.

The surfactant may be non-ionic, ionic, or a mixture of non-ionic and ionic. For example, in embodiments, the surfactant consists of a non-ionic surfactant. In other embodiments, the surfactant consists of an ionic surfactant. In still other embodiments, the surfactant can be a mixture of non-ionic and ionic surfactants.

In embodiments, an amount of a liquid vehicle, such as water, in the ink composition may be in a range of about 40 to about 90 parts by weight based on 100 parts by weight of the ink composition. When the amount of the liquid vehicle is less than about 40 parts by weight, the density of the coloring agent in the ink composition is increased and thus the viscosity of the ink composition is increased. When the amount of the liquid vehicle is greater than about 90 parts by weight, the amount of the coloring agent is too small to embody color.

In embodiments, the liquid vehicle can consist solely of water, or it can comprise a mixture of water and a water-soluble or water-miscible organic component. Suitable components for the liquid vehicle include, but are not limited to, water, ethylene glycol, propylene glycol, diethylene glycols, glycerine, dipropylene glycols, polyethylene glycols, polypropylene glycols, amides, ethers, urea, substituted ureas, ethers, carboxylic acids and their salts, esters, alcohols, organosulfides, organosulfoxides, sulfones (such as sulfolane), alcohol derivatives, carbitol, butyl carbitol, cellusolve, tripropylene glycol monomethyl ether, ether derivatives, amino alcohols, ketones, N-methylpyrrolidinone, 2-pyrrolidinone, cyclohexylpyrrolidone, hydroxyethers, amides, sulfoxides, lactones, polyelectrolytes, methyl sulfonylethanol, imidazole, betaine, other water-soluble or water-miscible materials, mixtures thereof, and the like.

In embodiments, the ink composition may further include an additive, such as a wetting agent, a dispersing agent, a viscosity-controlling agent, a pH controlling agent, an anti-oxidizing agent, and other agents conventionally included in an ink composition.

In embodiments, an amount of the additive in the ink composition may be in the range of about 7 to about 3000 parts by weight, such as about 10 to about 2000 parts by weight based on 100 parts by weight of the coloring agent.

In embodiments, the ink compositions can be prepared by any suitable process. For example, the ink compositions may be prepared by simply mixing the ink compositions' components. Various embodiments entail mixing all of the ink composition components together and filtering the mixture to obtain the ink composition. Embodiments of the ink compositions can be prepared by, for example, mixing the components, heating if desired, and filtering, followed by adding any desired additional additives to the mixture and mixing at a suitable temperature with moderate shaking until a homogeneous mixture is obtained, typically from about two to about 10 minutes. Alternatively, additives can be mixed with the other ink composition components during the preparation process, which takes place according to any desired procedure, such as by mixing all the ingredients, heating if desired, and filtering.

Embodiments of the present general inventive concept are also directed to processes that entail incorporating the ink compositions into an ink jet printing apparatus, and causing droplets of the ink compositions to be ejected in an image-wise pattern onto a recording sheet. In various embodiments, the printing apparatus employs a thermal ink jet process in which the ink composition in the nozzles is selectively heated in an image-wise pattern, thereby causing droplets of the ink to be ejected in image-wise pattern. In another embodiment, the printing apparatus employs an acoustic ink jet process, in which droplets of the ink are caused to be ejected in image-wise pattern by acoustic beams.

Any suitable substrate or recording sheet can be employed in embodiments of the printing processes. The suitable substrates may include, but are not limited to, plain papers such as Xerox.™. 4024 papers, Xerox.®. Image Series papers, Courtland 4024 DP paper, ruled notebook paper, bond paper, silica coated papers such as Sharp Company silica coated paper, JuJo paper, and the like, transparency materials, fabrics, textile products, plastics, polymeric films, inorganic substrates such as metals and wood, and the like. For example, the printing process may entail printing onto a porous or ink absorbent substrate, such as plain paper.

The present general inventive concept will be described in further detail with reference to the following examples. These examples are for illustrative purposes only and are not intended to limit the scope of the present general inventive concept or to limit the scope of the claims.

### EXAMPLES

Coloring agents, surfactants, and co-solvents used in the Examples and Comparative Examples are as follows:

<Coloring Agents>

Dye-C: Pro-jet Cyan 1 (Avecia)

Dye-M: Brill. Red F3B-SF (Clariant)

Dye-Y: Basacid Yellow 099 (BASF)

Dye-K: Schwarz SP (Bayer)

Pig-K: Cabot 200 (Cabot)

<Surfactants>

A: Polyoxyethylene(20) sorbitan monostearate (ICI, Mn 1312)

B: Sodium dioctyl sulfosuccinate (CYTEC, Mn 445)

C: TEGO Flow 425 (TEGO, Mn 1000-1500)

D: Nonylphenol Polyethylene Glycol Ether (Dow Chemical, Mn 617)

E: JONCRYL® 61 (Johnson Polymer, Mn 8500)

<Co-Solvents>

co-solvent 1: triethyleneglycol

co-solvent 2: propylene carbonate

co-solvent 3: thioglycol

co-solvent 4: tetramethylenesulfon

co-solvent 5: 2-methylthioethanol.

As indicated in Table 1, coloring agents, surfactants, co-solvents, and, in some cases additives, were mixed and water was added thereto until the mixture solution had a mass of 100 g. The resulting solutions were sufficiently mixed using a mixing device for 30 minutes or longer to produce homogeneous solutions, and then refined using 0.45 μm filter, thus producing ink compositions.

TABLE 1

| | Coloring agent | Surfactant | Co-solvent | Additive(s) |
|---|---|---|---|---|
| Sample | (amount*) | (amount*) | (amount*) | (amount**) |
| Example 1 | Dye-C(4) | A(1) | co-solvent1 (6) | Glycerin(250) |
| Example 2 | Dye-M(4) | B(0.8) | co-solvent2 (5) | Glyerin(150), |
| | | | | 2-Py(100) |
| Example 3 | Dye-Y(4) | C(1) | co-solvent3 (5) | EG(250) |
| Example 4 | Dye-K(5) | D(1) | co-solvent4 (6) | 1,5-Pentanediol(200) |
| Example 5 | Pig-K(5) | A(1.5) | co-solvent5 (4) | EG(100), |
| | | | | Caprolactam(120) |
| Comparative | Dye-C(4) | A(1) | — | EG(200), Glycerin(200) |
| Example 1 | | | | |
| Comparative | Dye-M(4) | B(0.8) | — | Glycerin(150), 2-Py(200) |
| Example 2 | | | | |
| Comparative | Dye-M(4) | C(0.05) | co-solvent3 (5) | EG(250) |
| Example 3 | | | | |
| Comparative | Dye-Y(4) | C(10) | co-solvent1 (5) | Glycerin(250) |
| Example 4 | | | | |
| Comparative | Dye-K(5) | E(1) | co-solvent2 (6) | 1,5-Pentanediol(150), |
| Example 5 | | | | EG(120) |
| Comparative | Pig-K(5) | D(4) | co-solvent3 (0.5) | EG(200) |
| Example 6 | | | | |

*The amounts of the coloring agents, surfactants, co-solvents were measured based on 100 parts by weight of the ink compositions.
**The amounts of additive(s) were measured based on 100 parts by weight of the coloring agent.

### Experimental Example 1

### Anti-Forming Test

3 ml solutions of each of the ink compositions of Examples 1 through 5 and Comparative Examples 1 through 6 were separately added to 10 ml mess cylinders. The cylinders were sealed and then strongly shaken 10 times. The heights of the resulting foams were measured, and then volume ratios of the ink compositions to the foams were measured. The results are shown in Table 2.

Volume Ratio (%)=(height of foam-initial height of ink)/(initial height of ink)×100

?: 0%=Volume ratio=150%

?: 150%<Volume ratio=300%

X: 300%<Volume ratio=400%

XX: 400%<Volume ratio

### Experimental Example 2

### Long-Term Storage Stability of Ink

100 ml samples of each of the ink compositions of Examples 1 through 5 and Comparative Examples 1 through 6 were separately added to heat resistant glass bottles. The bottles were sealed and then stored in a constant-temperature container at 60° C. for 2 months. The bottles were then analyzed to determine whether the ink composition precipitated and to determine whether layers were separated. The results are shown in Table 2.

### Experimental Example 3

### Image Test

∘: no precipitation, no layer separation

Δ: no precipitation, layer separation

X: precipitation

Among the ink compositions according to Examples 1 through 5 and Comparative Examples 1 through 6, colored inks were filled in ink C-60 cartridges (obtained from Samsung Co., Ltd.) and black inks were filled in ink M-50 cartridges (obtained from Samsung Co., Ltd.). These inks were used to print images of solid boxes (10 cm×10 cm) using a printer (MJC-2400C, obtained from Samsung Co., Ltd.) and then, white lines formed in the solid boxes were measured. The results are shown in Table 2.

∘: no precipitation, no layer separation

Δ: no precipitation, layer separation

X: precipitation

### Experimental Example 4

### Test for Nozzle Clogging

Among the ink compositions according to Examples 1 through 5 and Comparative Examples 1 through 6, colored inks were filled in C-60 ink cartridges (obtained from Samsung Co., Ltd.) and black inks were filled in M-50 ink cartridges (obtained from Samsung Co., Ltd.). These cartridges were left sitting at 25° and −18° each for 2 weeks, and then used for printing. Before the printing, a nozzle was repeatedly cleaned until normal printing was able to be obtained. The results are shown in Table 2.

TABLE 2

| | | Long-term | | |
|---|---|---|---|---|
| | Anti- | Storage | Image | Nozzle |
| Sample | Foaming | Stability | Performance | Clogging |
| Example1 | ⊚ | ◯ | ◯ | ◯ |
| Example2 | ◯ | ◯ | ◯ | ⊚ |
| Example3 | ◯ | ◯ | ◯ | ⊚ |
| Example4 | ⊚ | ◯ | ◯ | ◯ |
| Example5 | ◯ | ◯ | ◯ | ⊚ |
| Comparative | X | ◯ | ◯ | ◯ |
| Example1 | | | | |
| Comparative | XX | ◯ | ◯ | ⊚ |
| Example2 | | | | |
| Comparative | ⊚ | ◯ | X | ◯ |
| Example3 | | | | |
| Comparative | X | Δ | Δ | XX |
| Example4 | | | | |
| Comparative | ◯ | Δ | Δ | XX |
| Example5 | | | | |
| Comparative | XX | ◯ | Δ | X |
| Example6 | | | | |

⊚: When normal printing was obtained after the nozzle was cleaned one time
?: When normal printing was obtained after the nozzle was cleaned two to four times
X: When normal printing was obtained after the nozzle was cleaned five to ten times
XX: When normal printing was not able to obtained even after the nozzle was cleaned as many as eleven times

Referring to Table 2, the ink compositions according to Examples 1 through 5 did not foam significantly, and could be stably stored for a long time (e.g., two months) without clogging the nozzle of the cartridge, and good images could be formed from these ink compositions.

On the other hand, when the amount of the surfactant was less than 0.07 (Comparative Example 3), foaming was prevented successfully but many while lines were formed when printing. When the amount of the surfactant was too high (Comparative Example 4), or when the amount of the co-solvent was too low or the mixture ratio of the surfactant to the co-solvent was outside a suitable range (Comparative Example 6), foaming could not be prevented, image properties deteriorated, and when ink was stored for a long time, the nozzle was clogged. In addition, when the number average molecular weight (Mn) of the surfactant was too high (Comparative Example 5), foaming was successfully prevented, but the nozzle was clogged.

Thus, the present general inventive concept provides for an ink composition that can be stably stored for a long time without clogging a nozzle of a cartridge, and without foaming.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink composition comprising a coloring agent, a surfactant, a liquid vehicle, and a co-solvent, wherein the surfactant is an oligomer with a number average molecular weight of 8000 or less and the amount of the surfactant is in the range of 0.01 to 9 parts by weight based on 100 parts by weight of the ink composition, and the co-solvent is a C1-C20 ether, a C1-C20 ester compound, a C1-C20 carbonate compound, or a C1-C20 sulfur containing compound which contains a hetero atom having at least one unshared electron pair.

2. The ink composition of claim 1, wherein an amount of the co-solvent in the ink composition is about 1 to about 40 parts by weight based on 100 parts by weight of the ink composition.

3. The ink composition of claim 1, wherein a weight ratio of the surfactant to the co-solvent in the ink composition is about 1:4000 to about 9:1.

4. The ink composition of claim 1, wherein a weight ratio of the surfactant to the co-solvent in the ink composition is about 1:570 to about 7:1.

5. The ink composition of claim 1, wherein a weight ratio of the surfactant to the co-solvent in the ink composition is about 1:200 to about 5:1.

6. The ink composition of claim 1, wherein a volume of foam in the ink composition is 300% or less than an initial volume of the ink composition.

7. The ink composition of claim 1, wherein a volume of foam in the ink composition is 250% or less than an initial volume of the ink composition.

8. The ink composition of claim 1, wherein the co-solvent comprises at least one compound selected from the group consisting of diethyleneglycol, triethyleneglycol, tetrahydrofuran, dioxane, ethyl acetate, ethyl lactate, ethylene carbonate, propylene carbonate, diethyleneglycol monobutyl ether, triethyleneglycol monobutyl ether, propylene glycol monobutyl ether, dipropylene glycol monobutylether dimethylsulfoxide, tetramethylenesulfone, butadienesulfone, thioglycol, and 2-methylthioethanol.

9. The ink composition of claim 1, wherein the surfactant comprises at least one member selected from the group consisting of:
a salt of C1-C1000 alkylcarboxylic acid, a salt of C1-C1000 alcohol sulfonic acid ester, a salt of C1-C1000 alkylsulfonic acid, a salt of C1-C1000 alkylbenzenesulfonic acid, and a mixture of these;
a fatty acid amine salt, a tertiary ammonium salt, a sulfonium salt, a phosphonium salt, and a mixture of these;
polyoxyethylene alkyl ether, polyoxyethylene alkyl phenyl ether, polyoxyethylene secondary alcohol ether, a polyoxyethylene-oxypropylene block copolymer, polyglycerine ester of fatty acids, sorbitane ester of fatty acids, and a mixture of these; and
an acetylenic glycol compound, a secondary alcohol ethoxylate compound, and a mixture of these.

10. The ink composition of claim 1, wherein an amount of a liquid vehicle in the ink composition is about 40 to about 90 parts by weight based on 100 parts by weight of the ink composition.

11. The ink composition of claim 10, wherein the liquid vehicle comprises water.

12. The ink composition of claim 1, further comprising at least one agent selected from the group consisting of a wetting agent, a dispersing agent, a viscosity-controlling agent, a pH-controlling agent, and an anti-oxidizing agent.

13. The ink composition of claim 12, wherein an amount of the at least one agent in the ink composition is about 7 to about 3000 parts by weight based on 100 parts by weight of the coloring agent.

14. The ink composition of claim 12, wherein an amount of the at least one agent in the ink composition is about 10 to about 2000 parts by weight based on 100 parts by weight of the coloring agent.

15. The ink composition of claim 1, wherein the surfactant is an oligomer that has a number average molecular weight of about 3000 or less.

16. The ink composition of claim 1, wherein the surfactant is an oligomer that has a number average molecular weight of about 50 to about 2200.

17. The ink composition of claim 1, wherein an amount of the surfactant in the ink composition is about 0.07 to about 7 parts by weight based on 100 parts by weight of the ink composition.

18. The ink composition of claim 1, wherein an amount of the coloring agent in the ink composition is about 1 to about 15 parts by weight based on 100 parts by weight of the ink composition.

19. The ink composition of claim 1, wherein an amount of the coloring agent in the ink composition is about 1 to about 10 parts by weight based on 100 parts by weight of the ink composition.

20. The ink composition of claim 1, wherein the surfactant comprises at least one of an ionic surfactant and a non-ionic surfactant.

21. The ink composition of claim 1, wherein the surfactant is an ionic surfactant.

22. The ink composition of claim 1, wherein the surfactant is a non-ionic surfactant.

23. The ink composition of claim 1, wherein the surfactant comprises a mixture of at least one ionic surfactant and at least one non-ionic surfactant.

24. The ink composition of claim 1, wherein the surfactant comprises at least one member selected from the group consisting of:
a salt of C10-C200 alkylcarboxylic acid, a salt of C10-C200 alcohol sulfonic acid ester, a salt of C10-C200 alkylsulfonic acid, a salt of C10-C200 alkylbenzenesulfonic acid, and a mixture of these;
a fatty acid amine salt, a tertiary ammonium salt, a sulfonium salt, a phosphonium salt, and a mixture of these;
a polyoxyethylene alkyl ether containing a C10-C200 alkyl group, a polyoxyethylene alkyl phenyl ether containing a C10-C200 alkyl group, a polyoxyethylene secondary alcohol ether, a polyoxyethylene-oxypropylene block copolymer, a polyglycerine ester of fatty acids, a sorbitane ester of fatty acids, and mixtures thereof; and
an acetylenic glycol compound, a secondary alcohol ethoxylate compound, and a mixture of these.

25. An ink jet printing apparatus, comprising a nozzle and an ink cartridge, the ink cartridge comprising an ink composition comprising a coloring agent, a surfactant, a liquid vehicle, and a co-solvent, wherein the surfactant is an oligomer with a number average molecular weight of 8000 or less and the amount of the surfactant is in the range of 0.01 to 9 parts by weight based on 100 parts by weight of the ink composition, and the co-solvent is a C1-C20 ether, a C1-C20 ester compound, a C1-C20 carbonate compound, or a C1-C20 sulfur containing compound which contains a hetero atom having at least one unshared electron pair.

26. A method of making the ink jet composition of claim 1, comprising mixing the coloring agent, the surfactant, the liquid vehicle, and the co-solvent, and filtering the mixture.

27. A printing process comprising: incorporating into an ink jet printing apparatus an ink composition comprising a coloring agent, a surfactant, a liquid vehicle, and a co-solvent, wherein the surfactant is an oligomer with a number average molecular weight of 8000 or less and the amount of the surfactant is in the range of 0.01 to 9 parts by weight based on 100 parts by weight of the ink composition, and the co-solvent is a C1-C20 ether, a C1-C20 ester compound, a C1-C20 carbonate compound, or a C1-C20 sulfur containing compound which contains a hetero atom having at least one unshared electron pair; and ejecting droplets of the ink composition in an image-wise pattern onto a substrate.

28. A process according to claim 27, wherein the printing apparatus employs an ink jet process wherein the ink composition in nozzles of the printing apparatus is selectively heated in an image-wise pattern, to eject droplets of the ink composition in the image-wise pattern.

29. A process according to claim 27, wherein the printing apparatus employs an acoustic ink jet process wherein droplets of the ink composition are caused to be ejected in the image-wise pattern by acoustic beams.
